(19) United States
(12) Patent Application Publication
(10) Pub. No.: US 2025/0369337 A1
(43) Pub. Date: Dec. 4, 2025

(54) SYSTEM AND METHOD FOR AUTOMATIC CONVERSION OF INTERPRETED FEATURES ON BOREHOLE IMAGES TO DIGITAL LABELING FOR DEEP LEARNING

(71) Applicant: SAUDI ARABIAN OIL COMPANY, Dhahran (SA)

(72) Inventors: Chicheng Xu, Houston, TX (US); Tao Lin, Katy, TX (US); Lei Fu, Houston, TX (US); Weichang Li, Katy, TX (US); Yaser Alzayer, Dhahran (SA)

(73) Assignees: SAUDI ARABIAN OIL COMPANY, Dhahran (SA); ARAMCO SERVICES COMPANY, Houston, TX (US)

(21) Appl. No.: 18/733,222

(22) Filed: Jun. 4, 2024

(51) Int. Cl. E21B 47/002; G06V 10/44; G06V 10/82

(52) U.S. Cl. CPC E21B 47/002; G06V 10/44; G06V 10/82

(57) ABSTRACT

A method for determining descriptors associated with borehole images. The method includes obtaining N≥1 borehole images, where N is an integer, and locating, in each borehole image within the N borehole images, one or more geological features associated with the borehole image. The method further includes determining, for each borehole image within the N borehole images, one or more descriptors associated with the borehole image, where each descriptor of the one or more descriptors includes an optimum polygon enclosing a geological feature of the one or more geological features associated with the borehole image.

### BACKGROUND

A borehole image provides a visual representation of the interior face of a well. Geologists may interpret borehole images to analyze the lithology, stratigraphy, and structure of subsurface formations around wells. In the oil and gas industry, the interpretation of borehole images often reveals geological features, such as fractures, faults, vugs and nodules, that may affect the flow of hydrocarbons in a reservoir. The interpretation of borehole images may further help identify unstable geological formations and potential issues that could affect the stability of a wellbore.

Despite the rise of computerized tools, interpreting borehole images involves intensive manual work by experienced Earth scientists. Recently, machine learning models have been developed to automatize some of the interpretation tasks. However, properly labeled data is still lacking for training these models.

This disclosure proposes a technique to automatically convert interpreted products to digital labeled data, forming a database of properly labeled samples. This database is used for training deep learning models to detect geological features in borehole images.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for determining descriptors associated with borehole images. The method includes obtaining N≥1 borehole images, where N is an integer, and locating, in each borehole image within the N borehole images, one or more geological features associated with the borehole image. The method further includes determining, for each borehole image within the N borehole images, one or more descriptors associated with the borehole image, where each descriptor of the one or more descriptors includes an optimum polygon enclosing a geological feature of the one or more geological features associated with the borehole image.

In one aspect, embodiments disclosed herein relate to a system for determining descriptors associated with borehole images. The system includes a borehole data acquisition system configured to acquire borehole data from N≥1 boreholes, where N is an integer. The system further includes a borehole imager, configured to determine N borehole images, where each borehole image within the N borehole images is determined from borehole data for a distinct borehole within the N boreholes. The system further includes a geological locator, configured to locate, in a borehole image, one or more geological features associated with the borehole image, and a computer that includes one or more computer processors. The computer is configured to receive the N borehole images from the borehole imager and locate, using the geological locator, in each borehole image within the N borehole images, one or more geological features associated with the borehole image. The computer is further configured to determine, for each borehole image of the N borehole images, one or more descriptors associated with the borehole image, where each descriptor of the one or more descriptors includes an optimum polygon enclosing a geological feature of the one or more geological features associated with the borehole image.

In one aspect, embodiments disclosed herein relate to a non-transitory computer-readable memory for determining descriptors associated with borehole images. The non-transitory computer-readable memory includes computer-executable instructions stored thereon that, when executed on a processor, cause the processor to perform steps including obtaining N≥1 borehole images, where N is an integer, and locating, in each borehole image of the N borehole images, one or more geological features associated with the borehole image. The steps further include determining, for each borehole image of the N borehole images, one or more descriptors associated with the borehole image, where each descriptor of the one or more descriptors includes an optimum polygon enclosing a geological feature of the one or more geological features associated with the borehole image.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a well, in accordance with one or more embodiments disclosed herein.

FIG. 2A depicts a wall of a portion of a borehole, in accordance with one or more embodiments disclosed herein.

FIG. 2B depicts a curved rectangle, in accordance with one or more embodiments disclosed herein.

FIG. 2C depicts projection of a wall of a portion of a borehole, in accordance with one or more embodiments disclosed herein.

FIG. 3A depicts an example ultrasonic borehole image, in accordance with one or more embodiments disclosed herein.

FIG. 3B depicts an example formation microresistivity image, in accordance with one or more embodiments disclosed herein.

FIG. 4 depicts a depicts a system for labeling a borehole image, in accordance with one or more embodiments disclosed herein.

FIG. 5 depicts system for extending an interpretation dataset, in accordance with one or more embodiments disclosed herein.

FIG. 6 depicts a system for constructing and determining a geological map, in accordance with one or more embodiments disclosed herein.

FIG. 7 depicts a method for obtaining an optimum polygon, in accordance with one or more embodiments disclosed herein.

FIGS. 8A and 8B depict a method for obtaining one or more interpretation examples, in accordance with one or more embodiments disclosed herein.

FIG. 9 depicts an example diagram of a neural network, in accordance with one or more embodiments disclosed herein.

FIG. 10 depicts an example diagram of a computer, in accordance with one or more embodiments disclosed herein.

FIG. 11A depicts an example interpretation of a fracture, in accordance with one or more embodiments disclosed herein.

FIG. 11B depicts an example iteration of an optimizer, in accordance with one or more embodiments disclosed herein.

FIG. 12A depicts an example result of a new geological feature, in accordance with one or more embodiments disclosed herein.

FIG. 12B depicts an example result of a new geological feature, in accordance with one or more embodiments disclosed herein.

FIG. 13A depicts example results of some steps of an optimizer, in accordance with one or more embodiments disclosed herein.

FIG. 13B depicts a brightness distribution, in accordance with one or more embodiments disclosed herein.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a computer may reference two or more such computers.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

Terms such as “approximately,” “about,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. For example, these terms may mean that there can be a variance in value of up to +10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

It is to be understood that one or more of the steps shown in a flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

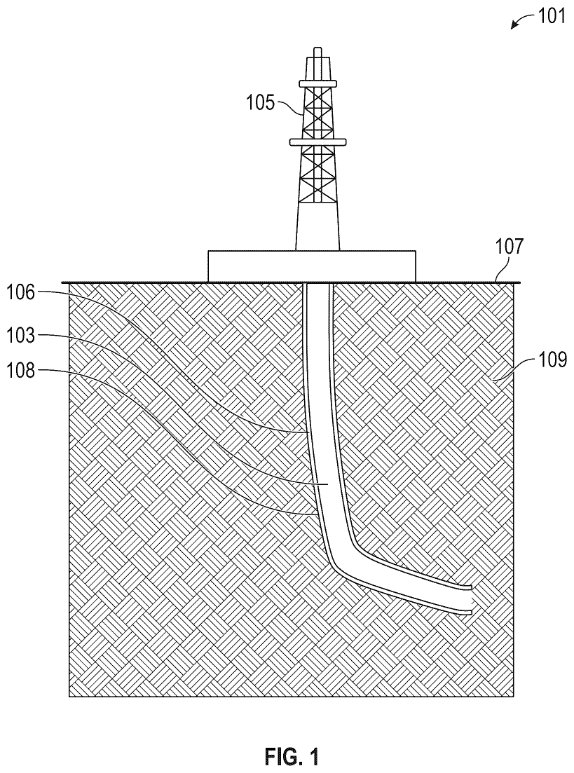

In the following description of FIGS. 1-12B, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Methods and systems are disclosed for generating labeled datasets representing geological features in borehole images. The labeled data may be used for training artificial intelligence models to detect geological features on borehole images, among other uses. Detected geological features may be used to produce geological maps of subsurface formations, among other uses.

FIG. 1 depicts a well (101), located on land. The well (101) is not intended to be limiting to any particular configuration. In other examples, the well (101) may be located offshore. A borehole (103) is drilled in a subsurface (109) in order to extract production fluids. In some instances, a derrick (105), located on the surface (107), may be used to drill the borehole (103) or extract production fluids from the subsurface (109), through the borehole (103). In instances where the well (101) is a hydrocarbon production well, production fluids may be oil, gas, water, or any combination thereof. The borehole (103) may be straight or curved. A straight borehole may be vertical or tilted. A casing (106), disposed in the well (101) against the borehole (103), is typically formed of a durable material such as steel. The casing (106) may support the borehole (103). A wellbore (108) includes the borehole (103) and the casing (106).

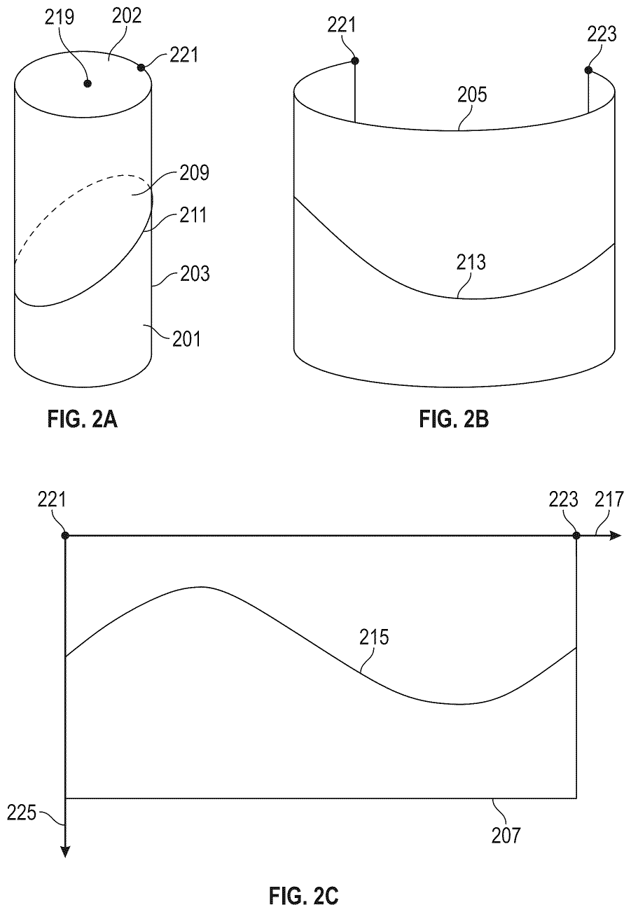

A borehole image is an image of all, or a portion of a wall of a borehole. FIG. 2A shows a wall (203) of a cylindrical portion (201) of a borehole. A disk, with center (219), is a base (202) of the cylindrical portion (201). The cylindrical portion (201) has a longitudinal axis of symmetry passing through the center (219) and parallel to the wall (203). The wall (203) is represented by a rectangle (207) in FIG. 2C, via a mathematical projection that unfolds the wall (203). For illustration purposes, a partially unfolded representation of the wall (203) appears as a curved rectangle (205) in FIG. 2B. In one or more embodiments, the borehole image is a rectangular image of the rectangle (207), rather than a cylindrical image of the wall (203). The azimuth of a point A located on the wall (203) is an angle between a first line segment and a second line segment. The first line segment connects an origin (221) to a center (219) of the base (202), as seen in FIG. 2A. The second line segment lies on a plane parallel to the base (202) and connects the longitudinal axis of symmetry to point A. In FIG. 2C, an azimuth axis (217) measures the azimuth for any point B in the rectangle (207). The azimuth of any point B in the rectangle (207) is defined as the azimuth of a point on the wall (203) that projects to point B in the rectangle (207). The origins (221), further depicted in FIGS. 2A and 2B, has an azimuth of zero. An azimuth of a closest point (223) to the origin (221) is vanishingly close to three hundred sixty degrees. In FIG. 2C, a depth axis (225) measures a depth, along the borehole, of any given point in the rectangle (207). The depth of any point B in the rectangle (207) is defined as the depth of a point on the wall (203) that projects to point B in the rectangle (207). If the borehole is vertical, the depth axis (225) measures a true vertical depth. If the borehole is tilted, the depth axis (225) measures a measured depth. If the borehole is curved, the depth axis (225) measures a curved depth along the curved borehole.

A borehole image may include intersections of geological features, such as bedding planes, faults, fractures, vugs and nodules, with the borehole wall (203). Knowledge of these features may be important for the characterization of a production fluid reservoir and the completion of the wellbore (108). A borehole image may further include drilling induced features such as breakouts, cave-ins, wear paths, notches, and other deviations from a smooth cylindrical hole that may be important for designing the completion of the wellbore (108) and the drilling of subsequent boreholes. Substantially planar geological features include, for example, geological bedding planes and fractures. In FIG. 2A, a substantially planar geological feature (209) intersects the borehole wall (203) at an oblique angle, forming a substantially elliptical pattern (211). The substantially elliptical pattern (211) transforms into a substantially sinusoidal pattern (215) in FIG. 2C via the mathematical projection that unfolds the borehole wall (203) into the rectangle (207). For illustration purposes, a partially unfolded representation of the substantially elliptical pattern (211) appears as a curved pattern (213) in FIG. 2B. Interpreting wellbore images may require locating and identifying substantially sinusoidal patterns such as the substantially sinusoidal pattern (215).

Borehole images may be obtained by using various techniques. Examples of techniques for obtaining borehole images include, but are not limited to optical imaging, acoustic imaging, magnetic resonance imaging and electrical imaging. Optical imaging involves lowering a camera, an optical televiewer or a fiber optic system into the borehole to capture an optical image of the borehole wall. Acoustic imaging involves emitting sonic waves that reflect onto the borehole wall as reflected waves. The reflected waves are captured by acoustic receivers and analyzed to create a borehole image. As a notable example, the scope of acoustic imaging includes ultrasonic imaging. In ultrasonic imaging, ultrasonic waves are emitted and received by ultrasonic transducers. The resulting borehole image is called an ultrasonic borehole image (UBI). Magnetic resonance imaging involves lowering, into the borehole, a magnetic resonance tool that emits radiofrequency pulses into surrounding rock formations. Generally, the surrounding rock formations are porous and contain pore fluids. The emitted pulses cause the hydrogen nuclei in the pore fluids to resonate and emit, in return, a resonated signal. The resonated signal is recorded by a receiver and analyzed to produce the borehole image. Electrical imaging involves lowering, into the borehole, an electrical imaging tool that includes an array of electrodes, positioned at different depths. Electrical current is emitted, through a first set of electrodes, into rock formations surrounding the borehole. The electrical current travels and is transformed, through the rock formations, into a transformed electrical current. The transformed electrical current is received by a second set of electrodes. A change of resistivity is computed from a difference between the received and the emitted electrical currents. A borehole image is then determined from the change of resistivity. Examples of an electrical imaging tool include a formation microscanner. The electrodes of a formation microscanner are disposed on a plurality of pads. A borehole image obtained from a formation microscanner is called a formation microresistivity image (FMI). It is emphasized that the methods described herein, for obtaining borehole images, are given only as examples and should be considered non-limiting. One with ordinary skill in the art will readily appreciate that other methods may be used to obtain borehole images without departing from the scope of this disclosure.

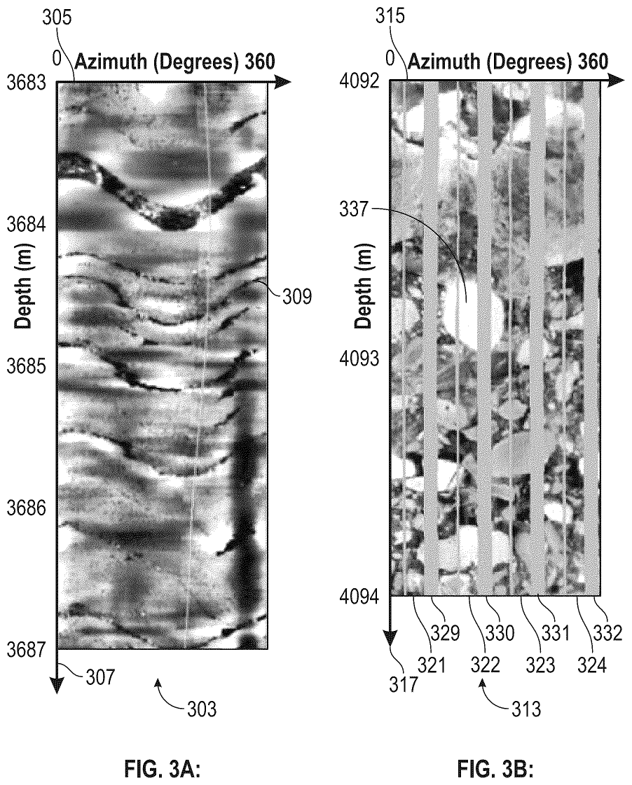

FIG. 3A depicts an example UBI (303). An azimuth axis (305) measures the azimuth in degrees that spans over three hundred sixty degrees. A depth axis (307) measures the depth in meters. In some embodiments, substantially sinusoidal patterns crossing homogenous rocks, such as a substantially sinusoidal pattern (309), are interpreted as fractures. FIG. 3B depicts an example FMI (313), obtained with a formation microscanner with four pads of electrodes. An azimuth axis (315) measures the azimuth in degrees that spans over three hundred sixty degrees. A depth axis (317) measures the depth in meters. The FMI (313) includes four pad images (321, 322, 323, 324). Each of the four pad images (321, 322, 323, 324) is obtained from a distinct pad of the microscanner. Unimaged portions (329, 330, 331, 332) are present between the pad images (321, 322, 323, 324), corresponding to areas of the borehole hole between the four pads. In accordance with some embodiments, the image of the borehole wall lying in the unimaged portions (329, 330, 331, 332) may be estimated, or interpolated, based on the pad images (321, 322, 323, 324) before the FMI (313) is interpreted. In other embodiments, the image of the borehole wall may be interpreted based on the pad images (321, 322, 323, 324), without interpolating unimaged portions (329, 330, 331, 332). In one more embodiments, homogeneous patches, such as a patch (337), are interpreted as vugs or nodules in the FMI (313).

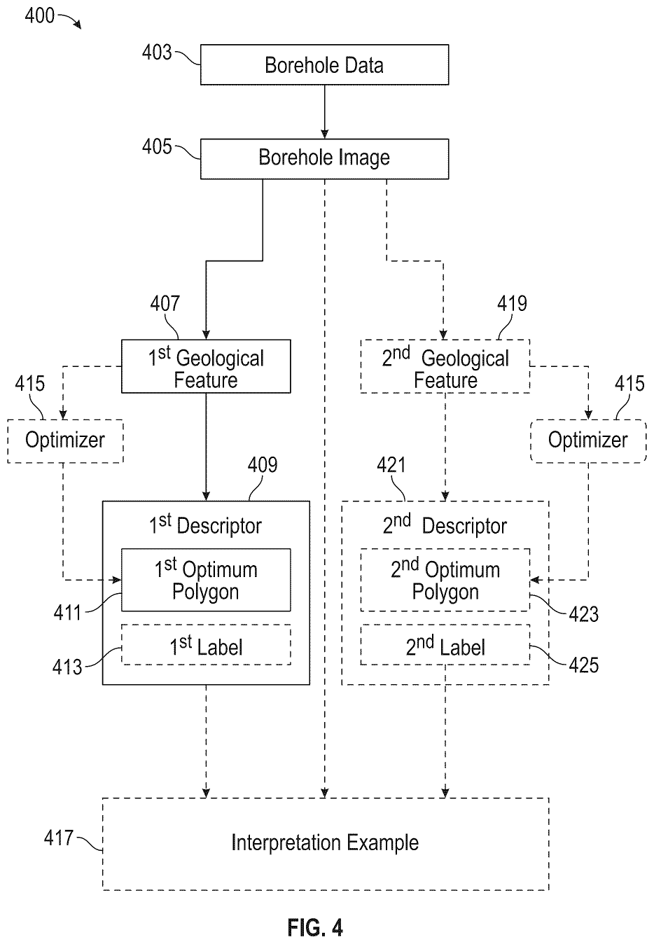

FIG. 4 depicts a system (400) for labeling a borehole image. A borehole image (405) is determined from borehole data (403). The borehole data (403) can be of several types, previously described. The borehole data (403) is acquired using a borehole data acquisition tool. Examples of borehole data include, but are not limited to, an optical signal from a camera, an ultrasonic signal from a transducer, an electromagnetic signal from a magnetic resonance tool and an electrical signal from a formation microscanner. In some embodiments, the borehole image (405) is determined from the borehole data (403) by using imaging software. In some embodiments, the imaging software is included in the borehole data acquisition tool. A first geological feature (407) is located in the borehole image (405). Examples of the first geological feature (407) include, but are not limited to, a fault, a fracture, a vug and a nodule. In some implementations, the first geological feature (407) is located using interpretation software. In other implementations, the first geological feature (407) is located using an interpretation database. The interpretation database includes an interpretation of the borehole image (405) that was carried out prior to using the system in FIG. 4. Locating the first geological feature (407) may be materialized by a geometrical object representing the first geological feature (407), such as a line, a curve and a segmented mask. For instance, a segmented mask may be defined as an image of a same size as the borehole image (405), the segmented masks composed of digital pixels with an amplitude equal to one if the pixel belongs to the first geological feature (407), and zero otherwise.

A first descriptor (409) is determined for the first geological feature (407). The first descriptor (409) includes a first optimum polygon (411) enclosing the first geological feature (407). In one or more embodiments, the first optimum polygon (411) is drawn, manually, around the first geological feature (407). Drawing the first optimum polygon (411) manually around the first geological feature (407) may be done, for instance, by using a graphical tool or software. It is noted that multiple polygons may enclose the first geological feature (407). Therefore, the first optimum polygon (411) is selected, according to a selection criterion, among all the polygons enclosing the first geological feature (407). In some embodiments, the first optimum polygon (411) is determined by randomly selecting any polygon that encloses the first geological feature (407). In other embodiments, the first optimum polygon (411) is determined by using an optimizer (415). In such implementations, a score may be assigned to any polygon enclosing the first geological feature (407). The optimizer (415) is configured to seek a polygon with a maximum score. The first optimum polygon (411) is then defined as the polygon that is found by the optimizer (415). In one or more embodiments, the optimizer is an iterative optimizer (415) that defines an iterated polygon at each iteration until a stopping criterion is reached. Examples of a stopping criterion are defined later in this disclosure. Examples of a stopping criterion include a maximum number of iterations, in which case the optimizer (415) stops when the maximum number of iterations is reached. The first optimum polygon (411) is then defined as the iterated polygon obtained by the optimizer at the last iteration, or the iterated polygon with the maximum score obtained by the optimizer until it stops. Examples of a stopping criterion further include a score threshold. In such scenarios, the optimizer stops as soon as an iterated polygon is found with a score exceeding the score threshold. The first optimum polygon (411) is then defined as the iterated polygon found by the optimizer with the score exceeding the score threshold.

In one or more embodiments, the score of a polygon is based on how closely the polygon encloses the first geological feature (407). A score based on how closely the polygon encloses the first geological feature (407) can be defined in many ways. In some implementations, the score of a polygon is an inverse of an area of the polygon. The smaller the area, the higher the score. In other scenarios, the score of a polygon is defined as a coherency of the borehole image (405) inside the polygon. Examples of coherencies include an average brightness of the borehole image (405) inside the polygon. In accordance with one or more embodiments, the pixels forming the first geological feature (407) in the borehole image (405) are brighter than pixels surrounding the first geological feature (407). Therefore, given a first polygon with a first area enclosing the first geological feature (407), and a second polygon with a second area enclosing the first geological feature (407), where the second area is smaller than the first area, the second polygon may have a higher average brightness than the first polygon. Therefore, in accordance with some embodiments, the average brightness inside a polygon is a measure of how closely the polygon encloses the first geological feature (407). Examples of coherencies further include a semblance of the borehole image (405) inside the polygon.

In one or more embodiments, the first descriptor (409) further includes a first label (413). The first label (413) is a categorical variable that identifies the first geological feature (407). In such scenarios, geological features are classified into a countable number of pre-defined categories. Examples of categories include, but are not limited to a fault, a fracture, a vug and a nodule. Examples for the first label (413) include a name of the category classifying the first geological feature (407). For instance, if the first geological feature (407) is a fracture, the first label (413) may be defined as a text “fracture”. In some implementations, each category is assigned a distinct number that encodes the category. As a specific example, the “fault”, “fracture”, “vug” and “nodule” categories may be encoded as the integers one, two, three and four respectively. Then, if the first geological feature (407) is a fracture, the first label (413) may be defined as the integer two. In other implementations, the categories are one-hot encoded. In such scenarios, the first label (413) includes a plurality of binary classifiers, namely, one binary classifier associated with each possible value of the predefined categories. For any first category within the pre-defined categories, the value of the binary classifier associated with the first category is equal to one if the category of the first geological feature (407) is equal to the first category, and zero otherwise. As a specific example, if the pre-defined categories are “fault”, “fracture”, “vug” and “nodule”, the first label (413) has four binary classifiers: a first binary classifier associated with the “fault” category, a second binary classifier associated with the “fracture” category, a third binary classifier associated with the “vug” category and a fourth binary classifier associated with the “nodule” category. Then, if the first geological feature (407) is a fracture, the second binary classifier is assigned a value of one and the first, third and fourth binary classifiers are assigned a value of zero.

In one or more embodiments, the first descriptor (409) further includes one or more geophysical attributes describing the first geological feature (407). Examples of geophysical attributes describing the first geological feature (407) include, but are not limited to, a textual description of the first geological feature (407), an age of the first geological feature (407), a geological period for the first geological feature (407), a location of the first geological feature (407), rock properties around the first geological feature (407) and a depth of the first geological feature (407). Any geophysical attribute within the one or more geophysical attributes may be a numerical or a categorical variable. Examples of geophysical attributes describing the first geological feature (407) further include an encoded vector from an artificial intelligence encoder, such as an autoencoder, an embedding model, and any sequence of multiple layers of a neural network. Generally, an encoder includes a neural network, such as a CNN, composed of a plurality of layers including an output layer. The neural network is configured to perform a task and return an output corresponding to the task. The output is a result of the output layer. By contrast, the encoded vector is a result of a layer that is not the output layer. A notable example of an encoder is an auto-encoder. An autoencoder includes a plurality of layers run sequentially. The plurality of layers can be described as a first set of layers and a second set of layers. The autoencoder is trained to receive an input and return, through the plurality of layers, an output that is equal to the input. After training, the second set of layers is discarded and an encoding vector, for a given input, is computed as an output of the first set of layers. It is emphasized that the example geophysical attributes described herein are given only as examples and should be considered non-limiting. One with ordinary skill in the art will readily appreciate that geophysical attributes may be defined in other ways without departing from the scope of this disclosure. Generally, a format of the first descriptor (409) is either the first optimum polygon (411), or a set that includes the first optimum polygon (411) and one or more numerical values, one or more vectors of numbers, one or more categorical values, or any combination thereof.

In one or more embodiments, a second geological feature (419) is located in the borehole image (405). A second descriptor (421) is determined for the second geological feature (419) in a similar fashion to the first descriptor (409) for the first geological feature (407). The second descriptor (421) has the same format as the first descriptor (409). As such, the second descriptor (421) includes a second optimum polygon (423) and may further include a second label (425) as well as one or more geophysical attributes. The second optimum polygon (423) may be determined using the same approach adopted to determine the first optimum polygon (411). In that respect, in some implementations, the second optimum polygon (423) is determined by using the optimizer (415). In a similar fashion, a third geological feature may be located in the borehole image (405) and associated with a third descriptor. Generally, one or more descriptors are associated with the borehole image (405) using the process in FIG. 4. Each descriptor within the one or more descriptors is associated with a distinct geological feature located in the borehole image (405). The borehole image (405) and the one or more descriptors associated with the borehole image (405) form an interpretation example (417). The interpretation example (417) is stored in a format that is readable by a computer. In one or more embodiments, the borehole image (405) and the one more descriptors associated with the borehole image (405) are digitized. The interpretation example (417) is then formed by digitized representations of the borehole image (405) and the one more descriptors associated with the borehole image (405). Throughout this disclosure, no distinction is made between any borehole image and a digital representation of the borehole image. Similarly, no distinction is made between any descriptor and a digital representation of the descriptor. That means, the term “borehole image” may refer to any representation of a borehole image and the term “descriptor” may refer to any representation of a descriptor. In one or more embodiments, the interpretation example (417) is stored as a file format known by those skilled in the art of artificial intelligence, such as a binary file format or a .json file format. In the interpretation example (417), the borehole image (405) is called an input of the interpretation example (417). In the interpretation example (417), the one or more descriptors are called an associated output (or target) associated with the input (i.e.: the borehole image (405)) of the interpretation example (417).

The process in FIG. 4 may be repeated for one or more other borehole images, different from the borehole image (405). One or more descriptors may be determined and associated with each distinct other borehole image within the one or more other borehole images. Then, one or more other interpretation examples are formed from the one or more other borehole images. Each other interpretation example includes an input borehole image from the one or more other borehole images and the descriptors associated with the input borehole image. In one or more embodiments, an interpretation dataset is formed, composed of the interpretation example (417) and the other interpretation examples. The interpretation dataset is composed of a plurality of interpretation examples. Each interpretation example within the interpretation dataset includes an input and an associated output (i.e.: target). For each interpretation example within the interpretation dataset, the input is a borehole image, and an associated output is a set of one or more descriptors associated with the input. For each interpretation example within the interpretation dataset, each descriptor within the target is associated with a geological feature located in the input.

Using the interpretation dataset, an artificial intelligence (AI) model is trained to receive, as input, a candidate borehole image and return, as output, one or more candidate descriptors associated with the input candidate borehole image. Once trained, the AI model is an automated borehole image interpretation algorithm. The one or more candidate descriptors output by the AI model constitute a predicted interpretation of the candidate borehole image. Each candidate descriptor within the one or more candidate descriptors is a prediction of a geological feature in the candidate borehole image. Each candidate descriptor within the one or more candidate descriptors includes, at least, a candidate optimum polygon. The candidate optimum polygon predicts a presence of a geological feature within the candidate optimum polygon. The AI model can be of several types. As non-limiting examples, the AI model may include a neural network, such as a fully connected neural network, a convolutional neural network, a recurrent neural network, or any combination of fully connected, convolutional, pooling, recurrent, or normalization layers. The AI model may include other structures outside of the ones described herein without departing from the scope of this disclosure.

Artificial intelligence models typically involve a training phase and a testing phase, using the interpretation dataset. In one or more embodiments, the interpretation dataset is split into a training dataset and a testing dataset. The example input and associated output pairs of the training dataset are called training examples. The example input and associated output pairs of the testing dataset are called testing examples. It is common practice to split the interpretation dataset in a way that the training dataset contains more examples than the testing dataset. Because data splitting is a common practice when training and testing a machine-learned model, it is not described in detail in this disclosure. One with ordinary skill in the art will recognize that any data splitting technique may be applied to the dataset without departing from the scope of this disclosure. The AI model is trained as a functional mapping that optimally matches the inputs of the training examples to the associated outputs of the training examples.

Once trained, the AI model is validated by computing a metric for the testing examples, in accordance with one or more embodiments. Denoting m as the number of testing examples, the input of the i^{th} testing example is denoted as xᵢ, for i=1, . . . , m. If the output of the interpretation examples includes one or more numerical component, the one or more numerical components of the output of the i^{th} testing example may be arranged as a vector yᵢ, for i=1, . . . , m. The output of the AI model receiving xᵢ as input also includes one or more numerical components, that may be arranged as a vector ŷᵢ, for i=1, . . . , m. In such scenarios, examples of metrics that may be used to validate the AI model include any scoring or comparison function known in the art, including but not limited to: a mean square error (MSE), a root mean square error (RMSE) and a coefficient of determination (R²), defined respectively as:

$$MSE = \frac{1}{m} {\sum }_{i = 1}^{i = m} {\vert {\hat{y}}_{i} - {y}_{i} \vert}^{2} , \qquad EQ . 1$$

$$RMSE = \sqrt{\frac{1}{m} {\sum }_{i = 1}^{i = m} {\vert {\hat{y}}_{i} - {y}_{i} \vert}^{2}} , \qquad EQ . 2$$

$${R}^{2} = 1 - \frac{{\sum }_{i = 1}^{i = m} {\vert {\hat{y}}_{i} - {y}_{i} \vert}^{2}}{{\sum }_{i = 1}^{i = m} {\vert {y}_{i} - {\overline{y}}_{i} \vert}^{2}} . \qquad EQ . 3$$

### In EQ. 1, EQ. 2, and EQ. 3,

$$\overline{y} = \frac{1}{m} {\sum }_{i = 1}^{i = m} {y}_{i} .$$

The notation |⋅| denotes a norm that can be applied to the object in between, such an l₂ norm. If the output of the interpretation examples includes a categorical component, the value of the categorical component for the i^{th} testing example may be denoted as yᵢ, for i=1, . . . , m. For all i=1, . . . , m, the value of yᵢ is a category within a plurality of categories Cⱼ, for j=1, . . . , C, where C denotes a number of categories in a classification. The output of the AI model receiving xᵢ as input includes a prediction for yᵢ, denoted by ŷᵢ, for i=1, . . . , m. In such scenarios, examples of metrics that may be used to validate the AI model include an accuracy (ACC), defined as:

$$ACC = \frac{1}{m} {\sum }_{i = 1}^{i = m} δ ( {\hat{y}}_{i} , {y}_{i} ) . \qquad EQ . 4$$

In EQ. 4, δ is the symbol of Kronecker, defined by δ(ŷᵢ, yᵢ)=1 if ŷᵢ=yᵢ, or δ(ŷᵢ, yᵢ)=0 otherwise. In some embodiments, the categorical component yᵢ is one-hot encoded as a vector with components yᵢ^{j}, for j=1, . . . , C, where

$${y}_{i}^{j} = δ ( {y}_{i} , {C}_{j} ) .$$

The prediction for yᵢ, denoted by ŷᵢ, is also a vector, with components

$${\hat{y}}_{i}^{j} ,$$

each component denoting a probability score between 0 and 1, for j=1, . . . , C. In these embodiments, examples of metrics that may be used to validate the classification AI model include a categorical cross-entropy (CAT), defined as:

$$CAT = - \frac{1}{m} {\sum }_{i = 1}^{i = m} {\sum }_{j = 1}^{j = C} {y}_{i}^{j} log ( {\hat{y}}_{i}^{j} ) . \qquad EQ . 5$$

In one or more embodiments, the outputs of the interpretation examples include one or more numerical components, one or more categorical components, or any combination thereof. In such embodiments, examples of metrics that may be used to validate the AI model include combinations of metrics taken from EQs. 1-5.

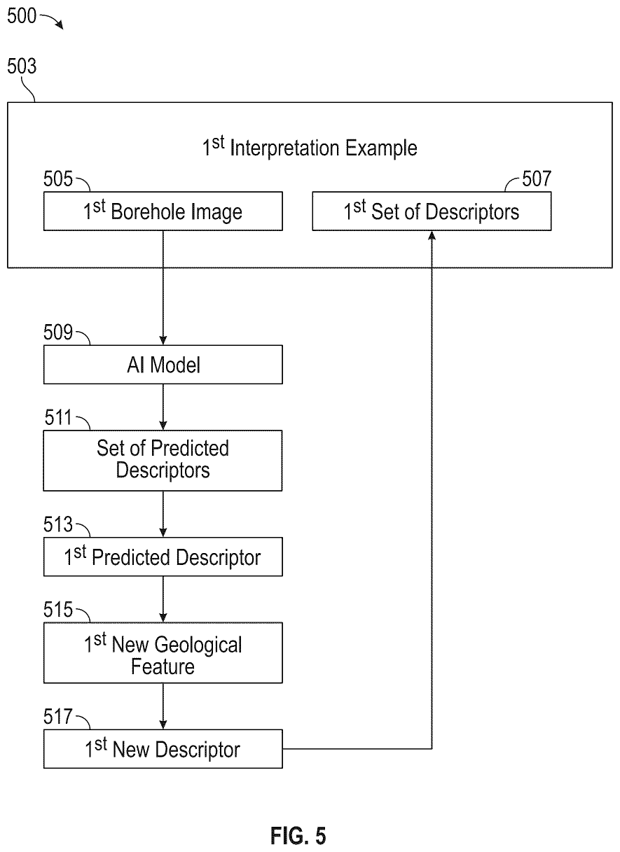

FIG. 5 depicts a system (500) for extending the interpretation dataset. A first interpretation example (503) includes a first borehole image (505) and one or more descriptors associated with the first borehole image (505), forming a first set of descriptors (507). Each descriptor within the first set of descriptors (507) is associated with a geological feature in the first borehole image (505). The geological features associated with the one or more descriptors associated with the first borehole image (505) form a first set of geological features associated with the first borehole image (505). In FIG. 5, the AI model is denoted as an AI model (509). The first borehole image (505) is sent as input to the AI model (509), that returns, as output, one or more predicted descriptors, forming a set of predicted descriptors (511). A first predicted descriptor (513) is taken from the set of predicted descriptors (511). The first predicted descriptor (513) includes a first predicted polygon. The first predicted polygon is predicted to enclose a geological feature in the first borehole image (505). However, the AI model might not deliver perfect results. In some scenarios, the first predicted optimum polygon intersects, without enclosing, a geological feature in the first borehole image (505). In other scenarios, the first predicted optimum polygon neither encloses nor intersects a geological feature in the first borehole image. In that respect, either one of two mutually exclusive situations a) or b) may happen: a) the area delimited by the first predicted optimum polygon intersects a geological feature in the first borehole image; b) the area delimited by the first predicted optimum polygon does intersect any geological feature in the first borehole image.

A first determination is made whether the area delimited by the first predicted optimum polygon intersects a geological feature in the first borehole image (505). The first determination can be made in several ways. In some embodiments, the first determination is made using interpretation software to locate any geological feature intersecting the area delimited by the first predicted optimum polygon. In other embodiments, the first determination is made visualizing the subimage of the first borehole image (505) that coincides with the first predicted polygon. If the area delimited by the first predicted optimum polygon intersects a geological feature, called a new geological feature, a second determination is made whether the new geological feature is element of the first set of geological features associated with the first borehole image (505). If the new geological feature is not element of the first set of geological features associated with the first borehole image (505), the new geological feature is qualified as a first new geological feature (515) associated with the first borehole image (505). The interpretation dataset is then extended by using an extension procedure. The extension procedure takes into account the first new geological feature (515) in the first interpretation example (503). The extension procedure includes determining a first new descriptor (517) for the first new geological feature (515). The first new descriptor (517) has a same format as any descriptor within the first set of descriptors (507). In one or more embodiments, the first new descriptor (517) is determined, for the first new geological feature (515), in a similar fashion to the first descriptor (409) for the first geological feature (407) in the system (400) in FIG. 4. The extension procedure further includes adding the first new descriptor (517) to the first set of descriptors (507). Adding the first new descriptor (517) to the first set of descriptors (507) extends the first interpretation example (503), and therefore, extends the interpretation dataset.

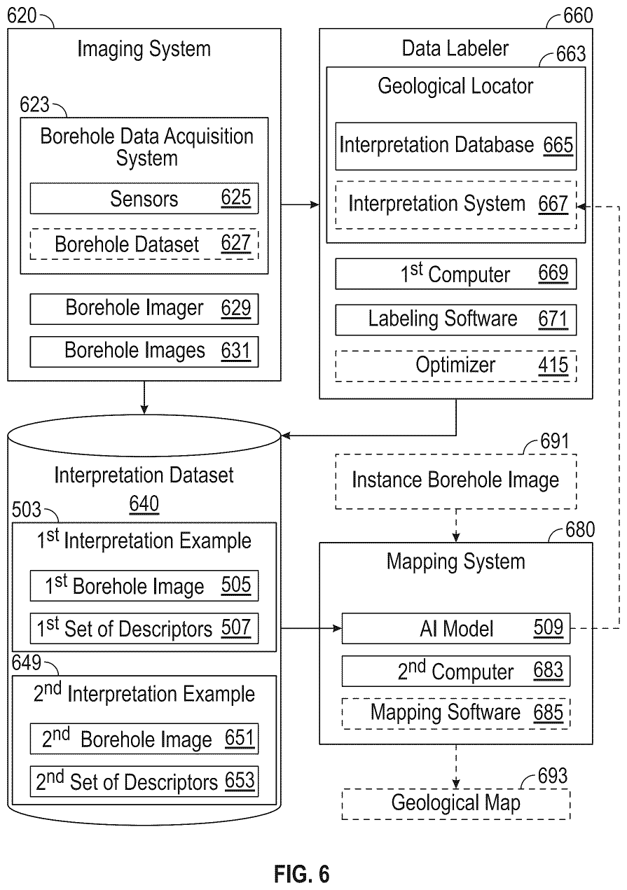

FIG. 6 depicts a system for constructing an interpretation dataset of interpretation examples, training an AI model using the interpretation dataset, and using the AI model to determine a geological map of rock formations surrounding a borehole. For concision, a full description of components and/or elements depicted in FIG. 6 is not provided anew for those components and/elements that have be previously described with reference to the preceding figures. The system in FIG. 6 includes an imaging system (620), a data labeler (660), an interpretation dataset (640) and a mapping system (680). The imaging system (620) includes a borehole data acquisition system (623). The borehole data acquisition system (623) includes sensors (625) configured to acquire borehole data from one or more boreholes. As previously described, the sensors (625) may include one or more of a camera, an optical televiewer, a fiber optic system, an ultrasonic transducer, a magnetic resonance tool and a formation microscanner. The borehole data acquired by the sensors may be stored in a borehole dataset (627). For each borehole within the one or more boreholes, a borehole image of the borehole is created using a borehole imager (629), resulting in the borehole images (631). Two distinct borehole images within the borehole images (631) may be of the same type or two distinct types. If the two images are obtained from borehole data acquired using similar instruments, the two images may be of the same type. For example, if a first borehole data is acquired with a first formation microscanner and a second borehole data is acquired with a second formation microscanner, a first borehole image may be obtained as a first FMI from the first borehole data and a second borehole image may be obtained as a second FMI from the second borehole data. The first borehole image and the second borehole image are both FMIs. On the other hand, if the first borehole data is acquired with a first formation microscanner and the second borehole data is acquired with an ultrasonic transducer, the first borehole image may be obtained as an FMI from the first borehole data and a second borehole image may be obtained as an UBI from the second borehole data. The first borehole image is an FMI and the second borehole image is an UBI.

The borehole imager (629) may have one or more components, depending on the borehole data acquired by the sensors (625). In some embodiments, the sensors (625) have only one component and the borehole imager (629) has only one component, configured to determine a borehole image from the data acquired by the unique component of the sensors (625). For instance, if the sensors (625) only include one or more formation microscanners, the borehole imager (629) may include a single component configured to determine a FMI from the electrical data acquired by a formation microscanner. In other embodiments, the sensors (625) have multiple components of different types and the borehole imager (629) includes a distinct component for each component of the sensors (625). For instance, if the sensors (625) include a formation microscanner and a camera, the borehole imager (629) may include two components. A first component of the borehole imager (629) is configured to determine a FMI from electrical data acquired by the formation microscanner. A second component of the borehole imager (629) is configured to determine an optical image from the optical data acquired by the camera. The timeframe to acquire borehole data and obtain the borehole images (631) may vary. In some implementations, a borehole image is determined from borehole data shortly after the borehole data is acquired by some of the sensors (625). For instance, a borehole image may be determined from borehole data within one hour after the borehole data is acquired. In other implementations, a borehole image is determined from borehole data long after the borehole data is acquired. For instance, a borehole image may be determined from borehole data one or more years after the borehole data is acquired.

In the same way, a first borehole data for a first borehole and a second borehole data for a second borehole may be determined simultaneously or at different times. For instance, the elapsed time between the acquisition of the first borehole data and a second borehole data may be a minute, a day, a year, a decade, or more. In the same way, the borehole images (631) may be determined simultaneously or at different times. In one or more embodiments, a sensor from the sensors (625) and a component of the borehole imager (629) are part of the same tool. For instance, a formation microscanner may be configured to both acquire electrical data and compute a borehole image from the acquired electrical data. It is also noted that some of the borehole images (631) may of a same borehole. Three examples are given herein, for two images of the same borehole. As a first example, a first borehole image is obtained from a first borehole data using a first imaging technology. Then, a second borehole image is obtained from the first borehole data using a second imaging technology. As a second example, a first borehole image is obtained from a first borehole data acquired using a formation microscanner. The first borehole image is a FMI. A second borehole image is obtained from a second borehole data acquired using an ultrasonic transducer. The second borehole image is a UBI. As a third example, a first borehole image is obtained from a first borehole data acquired using a first formation microscanner. The first borehole image is a first FMI. The second borehole image is obtained from a second borehole data acquired using a second formation microscanner, long after the first borehole data is acquired. For instance, the second borehole data may be acquired ten years after the first borehole data is acquired. The second borehole image is a second FMI, representing the borehole at a different time from the first FMI. In summary, the borehole images (631) include a plurality of borehole images, for one or more distinct boreholes, that may be determined at different times, from borehole data that may be acquired at different times.

The borehole images (631) are sent to the data labeler (660). The data labeler (660) includes a geological locator (663). The geological locator (663) is used to locate geological features in the borehole images (631). The geological locator (663) includes an interpretation database (665). The interpretation database (665) includes interpretations of geological features in the borehole images (631). Therefore, first strategy for locating geological features in the borehole images (631) is to look up the geological features from the interpretation database (665). In some embodiments, the geological features in the interpretation database (665) are interpreted in interpretation projects, called legacy projects, before the borehole images (631) are sent to the data labeler (660). In one or more embodiments, the geological locator (663) further includes an interpretation system (667). Therefore, a second strategy for locating geological features in the borehole images (631) is to interpret the geological features using the interpretation system (667). Then, the geological features are appended to the interpretation database (665). Regardless of which strategy is used for locating geological features in the borehole images (631), the interpretation database includes interpretations of the geological features in the borehole images (631). Generally, the interpretation system (667) includes interpretation software. The interpretation system may further include peripherals, such as a workstation, a monitor, a keyboard, a mouse, and a graphic tablet that enable efficient interaction between the geoscientists and the interpretation software. Geoscientists may use interpretation software to perform various interpretation tasks. Examples of interpretation tasks include interpreting geological features in the borehole images (631). Examples of interpretation tasks further include delimiting, using the interpreted geological features, stratigraphic layers, boundaries, and structural features of the subsurface around the boreholes. In that respect, the interpretation software may be equipped with various horizon picking tools, such as, for example, a hand-picking tool that allows a geoscientist to draw lines on the borehole images (631). The interpretation software may further be equipped with an automatic horizon tracking algorithm. An automatic horizon tracking algorithm allows a geoscientist to pick a geological event at a limited number of discreet points, called seed points, in a borehole image. Then, the automatic horizon tracking algorithm tracks the geological event from these seed points, resulting in a horizon. In some embodiments, the interpretation software further includes a machine learning model that receives a borehole image as input and returns, as output, a horizon, or a piece of a horizon.

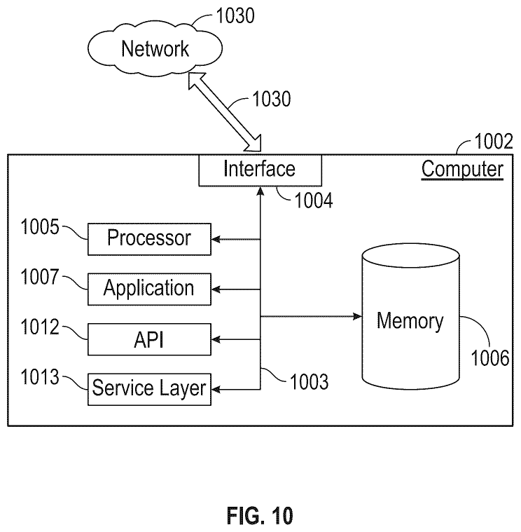

The data labeler further includes labeling software (671). The labeling software (671) is used to determine descriptors for the geological features interpreted in the borehole images (631). The descriptors are determined in a similar fashion to the first descriptor (409) and the second descriptor (421) for the borehole image (405) in FIG. 4. As such, in some embodiments, the labeling software (671) makes use of the optimizer (415). A descriptor includes an optimum polygon enclosing a geological feature. In some implementations, the labeling software (671) is included in the interpretation system (667). In such implementations, the interpretation system (667) allows a geophysicist to draw an optimum polygon enclosing a geological feature. In other implementations, the labeling software (671) is separate from the interpretation system (667) and includes a graphical tool that allows a geophysicist to draw an optimum polygon enclosing a geological feature. The labeling software (671) may further include a word processor that allows a geophysicist to assign a textual label, a textual description, or both, to a geological feature. The labeling software (671) may further include a machine learning encoder configured to compute an encoding vector for a geological feature. The labeling software (671) may further include the optimizer (415). The data labeler (660) further includes a first computer (669), on which the geological locator (663), the labeling software (671) and the optimizer (415) are hosted and run. The first computer (669) may be embodied by, for example, the computer system of FIG. 10.

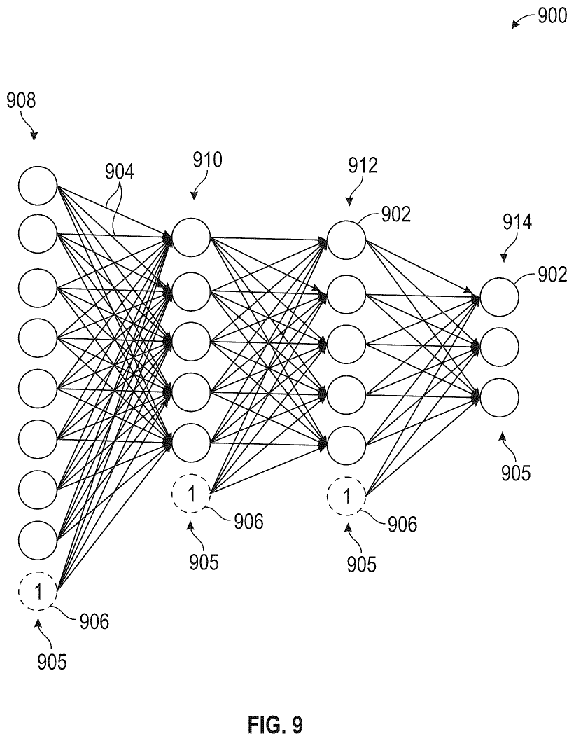

The borehole images (631) and the descriptors associated with the borehole images (631) are combined to form a plurality of interpretation examples, in a similar fashion to the interpretation example (417) in FIG. 4. The interpretation examples form an interpretation dataset (640). The plurality of interpretation examples in the interpretation dataset (640) includes a first interpretation example (503) and a second interpretation example (649). The first interpretation example (503) includes a first borehole image (505) and a first set of descriptors (507) associated with the first borehole image (505). The second interpretation example (649) includes a second borehole image (651) and a second set of descriptors (653) associated with the second borehole image (651). As previously described, the interpretation dataset is used to train and test the AI model (509). The AI model (509) is configured to receive, as input, a candidate borehole image and return, as output, one or more candidate descriptors associated with the input candidate borehole image. As such, the AI model (509) is an automated borehole image interpretation algorithm. In one or more embodiments, the AI model (509) includes a neural network, such as a fully connected neural network, a convolutional neural network, a recurrent neural network, or any combination of fully connected, convolutional, pooling, recurrent, or normalization layers. An example neural network is shown and described in FIG. 9.

The AI model (509) is integrated to a mapping system (680). The mapping system (680) includes a second computer (683), on which the AI model (509) is hosted and run. The second computer (683) may be embodied, for example, by the computer system shown in FIG. 10. In the example in FIG. 6, the different computing actions are associated with two different computing systems (“computers”), namely, the first computer (669) and the second computer (683). It is emphasized that the architecture of the computing components may vary, without departing from the scope of this disclosure. As such, the first computer (669) and the second computer (683) need not be separate entities. The first computer (669) and the second computer (683) may be the same computer. An example of a computer is described later in this disclosure in FIG. 10.

In some implementations, the AI model (509) is used to extend the interpretation dataset (640) by using the system (500) described in FIG. 5. The first borehole image (505) is sent to the AI model (509), that returns, as output, the set of predicted descriptors (511). The set of predicted descriptors (511) includes the first predicted descriptor (513). The first predicted descriptor (513) includes the first predicted optimum polygon. The set of predicted descriptors (511) is sent to the interpretation system (667). The interpretation system (667) is used to perform the first determination in the system (500), whether the area delimited by the first predicted optimum polygon intersects a new geological feature in the first borehole image (505). Then, the interpretation database is used to perform the second determination in the system (500), whether the new geological feature is element of the first set of geological features associated with the first borehole image (505). If the new geological feature is not an element of the first set of geological features associated with the first borehole image (505), an extension procedure is performed. The new geological feature is appended, as the first new geological feature (515), to the first set of geological features. An interpretation of the first new geological feature (515) is appended to the interpretation database (665). The labeling software (671) is then used to determine the first new descriptor (517) associated with the first new geological feature (515). The first new descriptor (517) is appended to the first set of descriptors (507), thereby extending the interpretation dataset (640). The system (500) may be further be used for a second predicted descriptor in the set of predicted descriptors (511). In a similar fashion, a second new geological feature may be determined from the second predicted descriptor. An interpretation of the second new geological feature is appended to the interpretation database (665). The labeling software (671) is then used to determine a second new descriptor associated with the second new geological feature. The second new descriptor is appended to the first set of descriptors (507), thereby extending the interpretation dataset (640). The extension procedure may be repeated for any other predicted descriptor in the set of predicted descriptors (511) to attempt to further extend the interpretation dataset (640). The extension procedure may further be applied to another one or more interpretation examples within the interpretation dataset (640). For example, the second borehole image (651) may be sent to the AI model (509), that returns a second set of predicted descriptors. The second set of predicted descriptors is then analyzed using the interpretation system (667) and the interpretation database (665). In some embodiments, analyzing the second set of predicted descriptors leads to adding new descriptors to the second set of descriptors (653), thereby extending the interpretation dataset (640).

Continuing with FIG. 6, in one or more embodiments, the mapping system (680) is used to map a vicinity of a specific borehole, called an instance borehole in the system FIG. 6. Mapping a vicinity of a borehole may be used in at least two scenarios. In a first scenario, the geology around the instance borehole is unknown, and the mapping is used to discover the geology around the instance borehole. In a second scenario, an estimate of the geology around the instance borehole is known. However, as the borehole imaging technology evolves, new borehole images allow for a more accurate interpretation of geological features. In the second scenario, the mapping may be used to refine, with a new borehole image, the estimate of the geology around the instance borehole. An instance borehole image (691) is obtained for the instance borehole. The instance image is not part of the borehole images (631). The instance borehole image was not used to train or test the AI model (509). The instance borehole image may be obtained using the borehole imager (629), or received from an existing database. The instance borehole image (691) is sent to the AI model (509), that returns, as output, one or more inferred descriptors associated with the instance borehole image (691). The inferred descriptors constitute a predicted interpretation of inferred geological features in the instance borehole image (691). Using the inferred geological features, a geological map (693) is built for a vicinity of the instance borehole.

In some embodiments, the geological map (693) is built by using mapping software (685), that may include various components. In some implementations, the mapping software (685) includes a graphic tool that allows a geoscientist to draw the geological map (693), based on the one or more inferred descriptors. In some implementations, the mapping software (685) and the interpretation software included in the interpretation system (667) are the same software. In some implementations, the mapping system (680) includes peripherals, such as a workstation, a monitor, a keyboard, a mouse, and a graphic tablet that enable efficient interaction between the geoscientists and the mapping software (685). In some implementations the peripherals included in the mapping software (685) and the peripherals included in the interpretation system (667) are the same peripherals. It is noted that the inferred geological features are predicted on the instance borehole wall only. However, the skilled in the art will appreciate that the geological map (693) may expand, in three space dimensions, to the inside of the instance borehole, and in a vicinity of the instance borehole. In that respect, the mapping software (685) may further include an interpolation procedure. The interpolation procedure is configured to interpolate the inferred geological features from the instance borehole wall to the inside of the instance borehole and extrapolate the inferred geological features from the instance borehole wall to the vicinity of the instance borehole. In some embodiments, the extrapolation of the inferred geological features from the instance borehole wall to the vicinity of the instance borehole involves interpolating the inferred geological features and geological features interpreted for other boreholes.

The geological map (693) may be used to locate a potential hydrocarbon reservoir in the subsurface. The geological map (693) may further be used to analyze properties and a potential for a hydrocarbon reservoir. The geological map (693) may further be used to identify unstable geological formations and potential issues that could affect the stability of a wellbore that includes the instance borehole. The geological map (693) may further be used to design a completion plan for wellbore associated with the instance borehole. In one or more embodiments, the geological map (693) is combined with external data. Examples of external data include well-log data, geological knowledge, and other geophysical information of the subsurface.

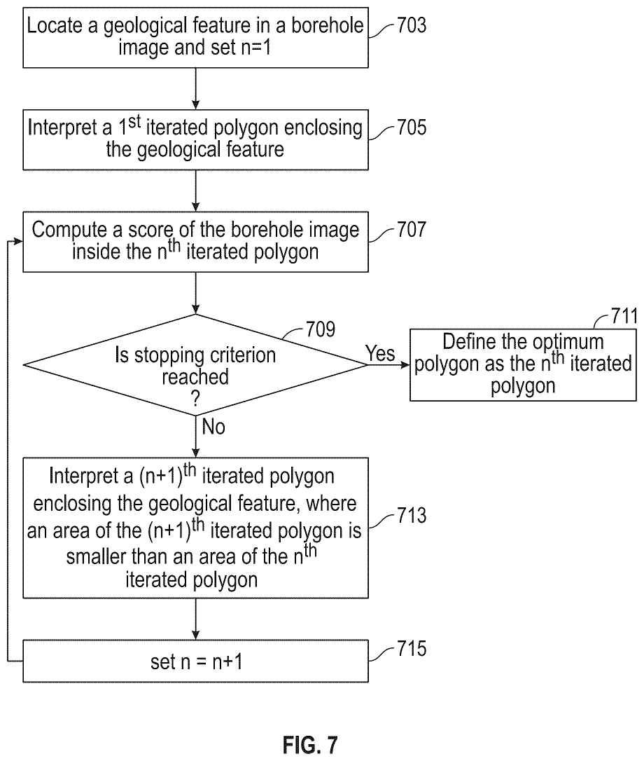

FIG. 7 depicts a process of the optimizer (415) configured to obtain an optimum polygon included in a descriptor associated with a geological feature. The optimizer in FIG. 7 is an iterative optimizer. In Step 703, a geological feature is located in a borehole image, in the same way as the first geological feature (407) is located in the borehole image (405) in the system in FIG. 4. An iterator n, set to one in Step 703, is a counter for a number of iterations for the optimizer. In Step 705, a first iterated polygon, that encloses the geological feature from Step 703, is interpreted. In one or more embodiments, Step 705 further includes initializing a Boolean convergence tag to “False”. In Step 707, a score is computed for the n^{th} iterated polygon. As previously described, the score in Step 707 may be defined in many ways. In one or more embodiments, the score of a polygon is an inverse of an area of the n^{th} iterated polygon. The smaller the area of the n^{th} iterated polygon, the higher the score. In other embodiments, the score of a polygon is defined as a coherency of the borehole image inside the n^{th} iterated polygon. Examples of coherencies include an average brightness of the borehole image inside the n^{th} iterated polygon. Examples of coherencies further include a semblance of the borehole image inside the n^{th} iterated polygon.

In Step 709, a determination is made whether a stopping criterion is reached. As previously described, the stopping criterion may be defined in many ways. In some embodiments, the stopping criterion is based on a maximum number of iterations: the stopping criterion is reached if the iterator n is equal to a pre-defined maximum number of iterations. On the other hand, the stopping criterion is not reached if the iterator n is less than the pre-defined maximum number of iterations. In some embodiments, the stopping criterion is based on a pre-defined score threshold. In such scenarios, the stopping criterion is reached if the score of the n^{th} iterated polygon exceeds the score threshold. On the other hand, the stopping criterion is not reached if the score of the n^{th} iterated polygon is less than the score threshold. In some embodiments, the stopping criterion is based on the convergence tag defined in Step 705. If the convergence tag is equal to “True”, the stopping criterion is reached. If the convergence tag is equal to “False”, the stopping criterion is not reached. It is noted that the example stopping criterion based on the convergence tag is never reached at the first iteration.

If the stopping criterion is reached in Step 709, the iterative solver stops in Step 711 and an optimum polygon is defined, for the geological feature from Step 703, as the n^{th} iterated polygon. If the stopping criterion is not reached in Step 709, a (n+1)th iterated polygon is interpreted in Step 713. The (n+1)th iterated polygon encloses the geological feature from Step 703. The (n+1)th iterated polygon is interpreted as having a smaller area than the n^{th} iterated polygon. The (n+1)th iterated polygon may be interpreted by various methods. In some implementations, the (n+1)^{th} iterated polygon is interpreted using a graphical tool. In some implementations, the (n+1)th iterated polygon is interpreted using interpretation software. In some implementations, the (n+1)th iterated polygon is interpreted using a segmentation algorithm. In some implementations, the (n+1)th iterated polygon is interpreted using artificial intelligence. In Step 715, the iterator n is incremented by one and the optimizer is re-iterated from Step 707.

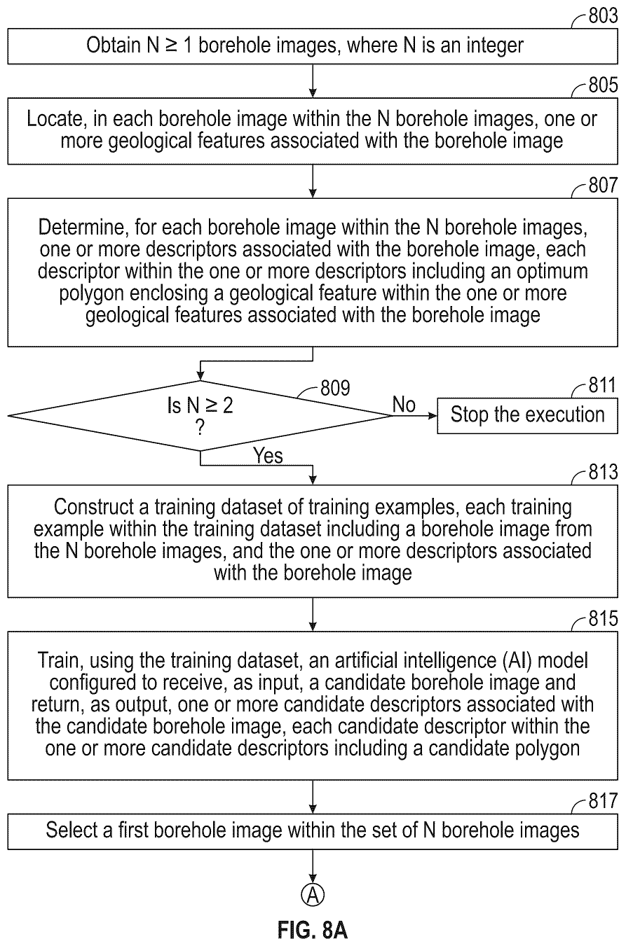

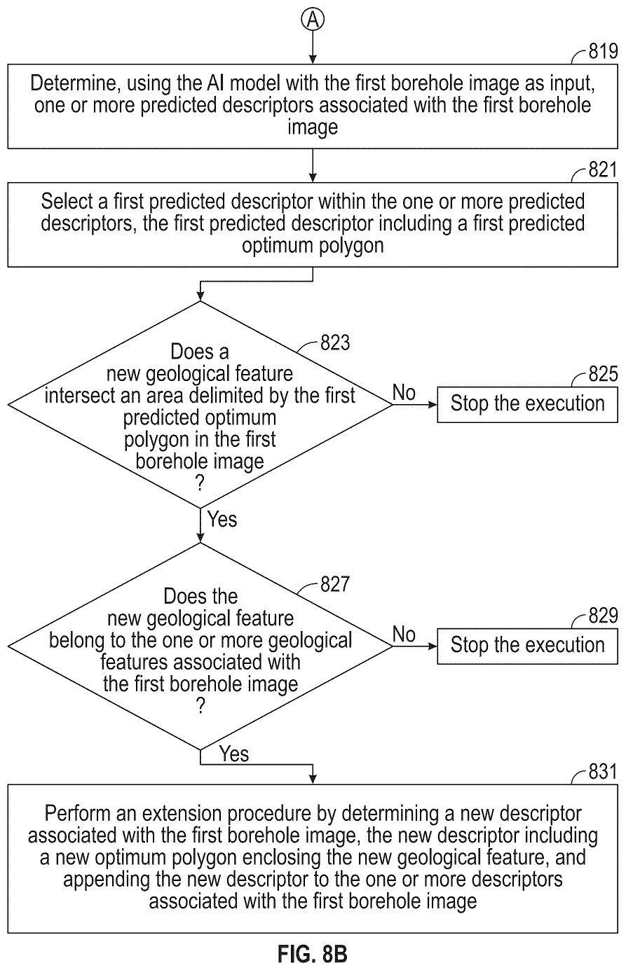

FIGS. 8A and 8B depict a method for obtaining one or more interpretation examples and creating a training dataset of training examples. For concision, a full description of components and/or elements depicted in FIGS. 8A and 8B is not provided anew for those components and/elements that have be previously described with reference to the preceding figures. In Step 803, N≥1 borehole images are obtained, where N is an integer. The N borehole images can be obtained in many ways. The N borehole images may be obtained, for example, from a database of existing borehole images. The N borehole images may further be obtained, for example, from borehole data by using a borehole imager such as the borehole imager (629) in FIG. 6. In Step 805, one or more geological features are located in each borehole image within the N borehole images. In some embodiments, the one or more geological features are extracted from an interpretation database, such as the interpretation database (665) in FIG. 6. In other embodiments, the one or more geological features are interpreted by using an interpretation system, such as the interpretation system (667) in FIG. 6. In Step 807, one or more descriptors are determined for each borehole image within the N borehole images. For each borehole image, each descriptor within the one or more descriptors is associated with a geological feature within the one or more geological features, obtained in Step 805, associated with the borehole image. The descriptors may be determined in many ways. In one or more embodiments, the descriptors are determined by using a labeling software, such as the labeling software (671) in FIG. 6. Each descriptor in Step 807 includes, at least, an optimum polygon enclosing the geological feature to which the descriptor is associated. In one or more embodiments, each optimum polygon is determined using an optimizer, such as the optimizer described in FIG. 7. The descriptors in Step 807 may further include other components. An example of a descriptor associated with a geological feature is given by the first descriptor (409) associated with the first geological feature (407) in FIG. 4. As such, each descriptor in Step 807 may further include a label, such as the first label (413) for the first descriptor (409) in FIG. 4. Each descriptor in Step 807 may further include one or more geophysical attributes describing the geological feature to which the descriptor is associated. Examples of geophysical attributes include a textual description, an age, a geological period, a location and a depth of the geological feature to which the descriptor is associated. Examples of geophysical attributes further include an encoding vector from a machine learning encoder.

In Step 809, a condition is tested. If the number N of borehole images in Step 803 is one, the method stops in Step 811. If N≥2, the method continues in Step 813. In Step 813, the borehole images from Step 803 and the descriptors from Step 807 are combined to form a plurality of interpretation examples. Each interpretation example is defined in the same way as the interpretation example (417) in FIG. 4. Each interpretation example includes an input and an associated output (i.e.: target). For each interpretation example, an input is a borehole image from Step 803 and an associated output is a set of the one or more descriptors associated with the input borehole image. The number of interpretation examples is the number N of borehole images. The interpretation examples form an interpretation dataset. A training dataset is extracted from the interpretation dataset. In some embodiments, the training dataset is the whole interpretation dataset. In other embodiments, the training dataset is a subset of the interpretation dataset. In one or more embodiments, the interpretation dataset is split into a training dataset and a testing dataset. The interpretation examples that belong to the training dataset are called training examples.

In Step 815, an artificial intelligence (AI) model is trained using the training dataset from Step 813. The AI model is trained to receive, as input, a candidate borehole image and return, as output, one or more candidate descriptors associated with the input candidate borehole image. The AI model is an automated borehole image interpretation algorithm. The AI model can be of several types. An example of the AI model in Step 815 is the AI model (509) in FIGS. 5 and 6. As previously described, the AI model may include a neural network, such as a fully connected neural network, a convolutional neural network, a recurrent neural network, or any combination of fully connected, convolutional, pooling, recurrent, or normalization layers. The AI model may have other structures than the ones described herein without departing from the scope of this disclosure. If the interpretation dataset is split into a training dataset and a testing dataset, the AI model may be trained using the training dataset and tested using the testing dataset. In some embodiments, the AI model is assessed by using metrics, such as the metrics in EQs. 1-5.

In Step 817, a first borehole image is selected within the N borehole images from Step 803. One or more geological features are associated with the first borehole image from Step 805. In some embodiments, the selection of the first borehole image is made randomly. In Step 819, the AI model from Step 815 is applied to the first borehole image and returns, as output, one or more predicted descriptors associated with the first borehole image. The one or more predicted descriptors in Step 819 are obtained in the same way as the set of predicted descriptors (511) in the system 500 in FIG. 5. In Step 821, a first predicted descriptor is selected from the one or more predicted descriptors. The first predicted descriptor includes a first predicted optimum polygon. The first predicted optimum polygon is predicted to enclose a geological feature in the first borehole image. However, the AI model might not deliver perfect results. In some scenarios, the first predicted optimum polygon intersects, without enclosing, a geological feature in the first borehole image. In other scenarios, the first predicted optimum polygon neither encloses nor intersects a geological feature in the first borehole image. In that respect, either one of two mutually exclusive situations a) or b) may happen: a) the area delimited by the first predicted optimum polygon intersects a geological feature in the first borehole image; b) the area delimited by the first predicted optimum polygon does not intersect any geological feature in the first borehole image.

A first determination is made whether the area delimited by the first predicted optimum polygon intersects a geological feature in the first borehole image (505). The first determination can be made in several ways. In some embodiments, the first determination is made using interpretation software to locate any geological feature intersecting the area delimited by the first predicted optimum polygon. In other embodiments, the first determination is made visualizing the subimage of the first borehole image (505) that coincides with the first predicted polygon. If the area delimited by the first predicted optimum polygon intersects a geological feature, called a new geological feature, a second determination is made whether the new geological feature is element of the first set of geological features associated with the first borehole image (505). If the new geological feature is not element of the first set of geological features associated with the first borehole image (505), the new geological feature is qualified as a first new geological feature (515) associated with the first borehole image (505). The interpretation dataset is then extended by using an extension procedure. The extension procedure takes into account the first new geological feature (515) in the first interpretation example (503). The extension procedure includes determining a first new descriptor (517) for the first new geological feature (515). The first new descriptor (517) has a same format as any descriptor within the first set of descriptors (507). In one or more embodiments, the first new descriptor (517) is determined, for the first new geological feature (515), in a similar fashion to the first descriptor (409) for the first geological feature (407) in the system (400) in FIG. 4. The extension procedure further includes adding the first new descriptor (517) to the first set of descriptors (507). Adding the first new descriptor (517) to the first set of descriptors (507) extends the first interpretation example (503), and therefore, extends the interpretation dataset.

In Step 823, a first determination is made whether the area delimited by the first predicted optimum polygon intersects a geological feature, called a new geological feature, in the first borehole image. If the area delimited by the first predicted optimum polygon does not intersect a new geological feature, the method stops in Step 825. If the area delimited by the first predicted optimum polygon intersects a new geological feature, a second determination is made in Step 827, whether the new geological feature is element of the first set of geological features associated with the first borehole image. If the new geological feature is one of the one or more geological features associated with the first borehole image, the method stops in Step 829. If the new geological feature is not one of the one or more geological features associated with the first borehole image, the interpretation dataset is extended by using an extension procedure in Step 831. The extension procedure is configured to account for the new geological feature in the interpretation example that has the first borehole image as input. In Step 831, a new descriptor is determined for the new geological feature. The new descriptor is of the same format as the descriptors from Step 807. The new descriptor includes a new optimum polygon enclosing the new geological feature. In some embodiments, the new optimum polygon is determined using an optimizer, such as the optimizer (415) in FIGS. 4 and 6. An implementation of the optimizer is described in FIG. 7. In some embodiments, the first predicted optimum polygon encloses the new geological feature and the new optimum polygon is the first predicted optimum polygon. In other embodiments, the first predicted optimum polygon encloses the new geological feature but is not considered as optimum. In such scenarios, although the first predicted optimum polygon encloses the new geological feature, the new optimum polygon must be determined by using, for example, the optimizer. If the optimizer is implemented as the method in FIG. 7, the first predicted optimum polygon, if enclosing the new geological feature, may be used as the first iterated polygon in Step 705 of the method in FIG. 7. In case the first predicted optimum polygon intersects, without enclosing, the new geological feature, the first predicted optimum polygon cannot be used as the first iterated polygon in Step 705 of the method in FIG. 7.

If the descriptors in Step 807 include other components, such as a label or geophysical attributes, the other components must also be determined for the new descriptor. In some embodiments, information about the new geological feature is inferred from the first borehole image or from external data, or both. External data may include, for example, well-log data, geological knowledge, and other geophysical information of the subsurface. The other components of the new descriptor are then determined in the same fashion to the components of the descriptors in Step 807. As previously described, determining the new descriptor may be done by using labeling software, such as the labeling software (671) in FIG. 6. The new descriptor is then appended to the one or more descriptors associated with the first borehole image.

As previously described, the AI model in this disclosure, represented by the AI model 509 in FIGS. 5 and 6, may be configured in many ways. Artificial intelligence (AI), broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term artificial intelligence will be adopted herein, however, one skilled in the art will recognize that the concepts and methods detailed hereafter are not limited by this choice of nomenclature.

AI model types may include, but are not limited to, generalized linear models, Bayesian regression, random forests, and deep models such as neural networks, convolutional neural networks, and recurrent neural networks. AI model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding an AI model is referred to as selecting the model “architecture.” Once an AI model type and hyperparameters have been selected, the AI model is trained to perform a task.

A notable example of an AI model that may be used as the AI model (509) is a neural network (NN), such as a convolutional neural network (CNN). A cursory introduction to a NN is provided herein. However, it is noted that many variations of a NN exist. Therefore, one with ordinary skill in the art will recognize that any variation of the NN (or any other AI model) may be employed without departing from the scope of this disclosure. Further, it is emphasized that the following discussions of a NN is a basic summary and should not be considered limiting.

A diagram of a neural network is shown in FIG. 9. At a high level, a neural network (900) may be graphically depicted as being composed of nodes (902), where here any circle represents a node, and edges (904), shown here as directed lines. The nodes (902) may be grouped to form layers (905). FIG. 9 displays four layers (908, 910, 912, 914) of nodes (902) where the nodes (902) are grouped into columns, however, the grouping need not be as shown in FIG. 9. The edges (904) connect the nodes (902). Edges (904) may connect, or not connect, to any node(s) (902) regardless of which layer (905) the node(s) (902) is in. That is, the nodes (902) may be sparsely and residually connected. A neural network (900) will have at least two layers (905), where the first layer (908) is considered the “input layer” and the last layer (914) is the “output layer.” Any intermediate layer (910, 912) is usually described as a “hidden layer.” A neural network (900) may have zero or more hidden layers (910, 912) and a neural network (900) with at least one hidden layer (910, 912) may be described as a “deep” neural network or as a “deep learning method.” In general, a neural network (900) may have more than one node (902) in the output layer (914). In this case the neural network (900) may be referred to as a “multi-target” or “multi-output” network.

Nodes (902) and edges (904) carry additional associations. Namely, every edge is associated with a numerical value. The edge numerical values, or even the edges (904) themselves, are often referred to as “weights” or “parameters.” While training a neural network (900), numerical values are assigned to each edge (904). Additionally, every node (902) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) , \qquad EQ . 6$$

where i is an index that spans the set of “incoming” nodes (902) and edges (904) and f is a user-defined function. Incoming nodes (902) are those that, when the neural network (900) is viewed or depicted as a directed graph (as in FIG. 9), have directed arrows that point to the node (902) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max (0, x), however, many additional functions are commonly employed. Every node (902) in a neural network (900) may have a different associated activation function. Often, as a shorthand, activation functions are described by the function ƒ by which it is composed. That is, an activation function composed of a linear function ƒ may simply be referred to as a linear activation function without undue ambiguity.

When the neural network (900) receives an input, the input is propagated through the network according to the activation functions and incoming node (902) values and edge (904) values to compute a value for each node (902). That is, the numerical value for each node (902) may change for each received input. Occasionally, nodes (902) are assigned fixed numerical values, such as the value of 1, that are not affected by the input or altered according to edge (904) values and activation functions. Fixed nodes (902) are often referred to as “biases” or “bias nodes” (906), displayed in FIG. 9 with a dashed circle.

In some implementations, the neural network (900) may contain specialized layers (905), such as a normalization layer, or additional connection procedures, like concatenation. One skilled in the art will appreciate that these alterations do not exceed the scope of this disclosure.

As noted, the training procedure for the neural network (900) comprises assigning values to the edges (904). To begin training the edges (904) are assigned initial values. These values may be assigned randomly, assigned according to a prescribed distribution, assigned manually, or by some other assignment mechanism. Once edge (904) values have been initialized, the neural network (900) may act as a function, such that it may receive inputs and produce an output. As such, at least one input is propagated through the neural network (900) to produce an output. Training data is provided to the neural network (900). Generally, training data consists of pairs of inputs and associated targets. The targets represent the “ground truth,” or the otherwise desired output, upon processing the inputs. In the context of this disclosure, an example input is a borehole image and an associated output, or target, is a set of one or more descriptors associated with the input borehole image. The target one or more descriptors describe geological features associated with the input borehole image. During training, the neural network (900) processes at least one input from the training data and produces at least one output. Each neural network (900) output is compared to its associated input data target. The comparison of the neural network (900) output to the target is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (900) output and the associated target. The loss function may also be constructed to impose additional constraints on the values assumed by the edges (904), for example, by adding a penalty term, which may be physics-based, or a regularization term. Generally, the goal of a training procedure is to alter the edge (904) values to promote similarity between the neural network (900) output and associated target over the training data. Thus, the loss function is used to guide changes made to the edge (904) values, typically through a process called “backpropagation.”

While a full review of the backpropagation process exceeds the scope of this disclosure, a brief summary is provided. Backpropagation consists of computing the gradient of the loss function over the edge (904) values. The gradient indicates the direction of change in the edge (904) values that results in the greatest change to the loss function. Because the gradient is local to the current edge (904) values, the edge (904) values are typically updated by a “step” in the direction indicated by the gradient. The step size is often referred to as the “learning rate” and need not remain fixed during the training process. Additionally, the step size and direction may be informed by previously seen edge (904) values or previously computed gradients. Such methods for determining the step direction are usually referred to as “momentum” based methods.

Once the edge (904) values have been updated, or altered from their initial values, through a backpropagation step, the neural network (900) will likely produce different outputs. Thus, the procedure of propagating at least one input through the neural network (900), comparing the neural network (900) output with the associated target with a loss function, computing the gradient of the loss function with respect to the edge (904) values, and updating the edge (904) values with a step guided by the gradient, is repeated until a termination criterion is reached. Common termination criteria are: reaching a fixed number of edge (904) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (904) values are no longer intended to be altered, the neural network (900) is said to be “trained.”

With respect to a CNN, it is useful to consider a structural grouping, or group, of weights. Such a group is herein referred to as a “filter.” The number of weights in a filter is typically much less than the number of inputs. In a CNN, the filters can be thought as “sliding” over, or convolving with, the inputs to form an intermediate output or intermediate representation of the inputs which still possesses a structural relationship. Like unto the neural network (900), the intermediate outputs are often further processed with an activation function. Many filters may be applied to the inputs to form many intermediate representations. Additional filters may be formed to operate on the intermediate representations creating more intermediate representations. This process may be repeated as prescribed by a user. There is a “final” group of intermediate representations, wherein no more filters act on these intermediate representations. In some instances, the structural relationship of the final intermediate representations is ablated; a process known as “flattening.” The flattened representation may be passed to a neural network (900) to produce a final output. Note, that in this context, the neural network (900) is still considered part of the CNN. Like unto a neural network (900), a CNN is trained, after initialization of the filter weights, and the edge (904) values of the internal neural network (900), if present, with the backpropagation process in accordance with a loss function.

The computations mentioned in this disclosure may be performed by a computer, such as the first computer (669) in FIG. 6. In that regard, FIG. 10 depicts a block diagram of a computer (1002) used to provide computational functionalities associated with described algorithms, methods, functions, processes, flows, and procedures as described in this disclosure, according to one or more embodiments. The illustrated computer (1002) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1002) may include a computer that includes an input device, such as a keypad, keyboard, touch screen, or other device that can accept user information, and an output device that conveys information associated with the operation of the computer (1002), including digital data, visual, or audio information (or a combination of information), or a GUI.

The computer (1002) can serve in a role as a client, network component, a server, a database or other persistency, or any other component (or a combination of roles) of a computer system for performing the subject matter described in the instant disclosure. In some implementations, one or more components of the computer (1002) may be configured to operate within environments, including cloud-computing-based, local, global, or other environments (or a combination of environments).

At a high level, the computer (1002) is an electronic computing device operable to receive, transmit, process, store, or manage data and information associated with the described subject matter. According to some implementations, the computer (1002) may also include or be communicably coupled with an application server, e-mail server, web server, caching server, streaming data server, business intelligence (BI) server, or other server (or a combination of servers).

The computer (1002) can receive requests over network (1030) from a client application (for example, executing on another computer (1002) and responding to the received requests by processing the said requests in an appropriate software application. In addition, requests may also be sent to the computer (1002) from internal users (for example, from a command console or by other appropriate access method), external or third-parties, other automated applications, as well as any other appropriate entities, individuals, systems, or computers.

Each of the components of the computer (1002) can communicate using a system bus (1003). In some implementations, any or all of the components of the computer (1002), both hardware or software (or a combination of hardware and software), may interface with each other or the interface (1004) (or a combination of both) over the system bus (1003) using an application programming interface (API) (1012) or a service layer (1013) (or a combination of the API (1012) and service layer (1013). The API (1012) may include specifications for routines, data structures, and object classes. The API (1012) may be either computer-language independent or dependent and refer to a complete interface, a single function, or even a set of APIs. The service layer (1013) provides software services to the computer (1002) or other components (whether or not illustrated) that are communicably coupled to the computer (1002). The functionality of the computer (1002) may be accessible for all service consumers using this service layer. Software services, such as those provided by the service layer (1013), provide reusable, defined business functionalities through a defined interface. For example, the interface may be software written in JAVA, C++, or other suitable language providing data in extensible markup language (XML) format or another suitable format. While illustrated as an integrated component of the computer (1002), alternative implementations may illustrate the API (1012) or the service layer (1013) as stand-alone components in relation to other components of the computer (1002) or other components (whether or not illustrated) that are communicably coupled to the computer (1002). Moreover, any or all parts of the API (1012) or the service layer (1013) may be implemented as child or sub-modules of another software module, enterprise application, or hardware module without departing from the scope of this disclosure.

The computer (1002) includes an interface (1004). Although illustrated as a single interface (1004) in FIG. 10, two or more interfaces (1004) may be used according to particular needs, desires, or particular implementations of the computer (1002). The interface (1004) is used by the computer (1002) for communicating with other systems in a distributed environment that are connected to the network (1030). Generally, the interface (1004) includes logic encoded in software or hardware (or a combination of software and hardware) and operable to communicate with the network (1030). More specifically, the interface (1004) may include software supporting one or more communication protocols associated with communications such that the network (1030) or interface's hardware is operable to communicate physical signals within and outside of the illustrated computer (1002).

The computer (1002) includes at least one computer processor (1005). Although illustrated as a single computer processor (1005) in FIG. 10, two or more processors may be used according to particular needs, desires, or particular implementations of the computer (1002). Generally, the computer processor (1005) executes instructions and manipulates data to perform the operations of the computer (1002) and any algorithms, methods, functions, processes, flows, and procedures as described in the instant disclosure.

The computer (1002) also includes a memory (1006) that holds data for the computer (1002) or other components (or a combination of both) that can be connected to the network (1030). The memory may be a non-transitory computer readable medium. For example, memory (1006) can be a database storing data consistent with this disclosure. Although illustrated as a single memory (1006) in FIG. 10, two or more memories may be used according to particular needs, desires, or particular implementations of the computer (1002) and the described functionality. While memory (1006) is illustrated as an integral component of the computer (1002), in alternative implementations, memory (1006) can be external to the computer (1002).

The application (1007) is an algorithmic software engine providing functionality according to particular needs, desires, or particular implementations of the computer (1002), particularly with respect to functionality described in this disclosure. For example, application (1007) can serve as one or more components, modules, applications, etc. Further, although illustrated as a single application (1007), the application (1007) may be implemented as multiple applications (1007) on the computer (1002). In addition, although illustrated as integral to the computer (1002), in alternative implementations, the application (1007) can be external to the computer (1002).

There may be any number of computers such as the computer (1002) associated with, or external to, a computer system containing computer (1002), wherein each computer (1002) communicates over network (1030). Further, the term “client,” “user,” and other appropriate terminology may be used interchangeably as appropriate without departing from the scope of this disclosure. Moreover, this disclosure contemplates that many users may use one computer (1002), or that one user may use multiple computers such as the computer (1002).

### Examples

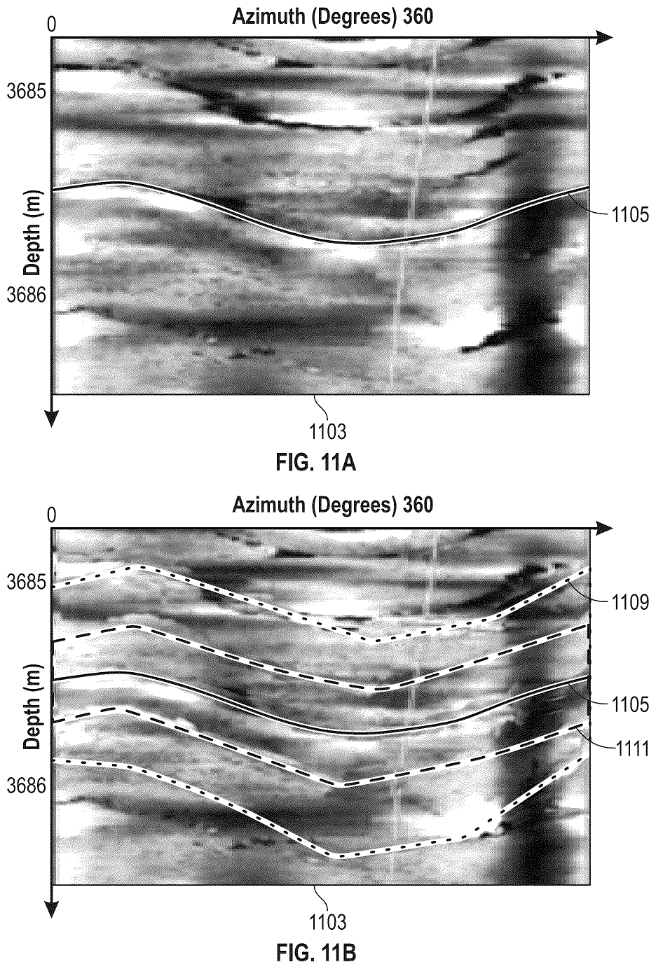

FIGS. 11A and 11B depict a synthetic example of an iteration of the method in FIG. 7 for obtaining an optimum polygon enclosing a geological feature. FIG. 11A depicts an UBI (1103) of a borehole. A geological feature (1105) is interpreted as a fracture, represented by a solid line. FIG. 11B depicts the same UBI (1103) and geological feature (1105) as in FIG. 11A. A first polygon (1109), represented by a dotted line, is interpreted as enclosing the geological features (1105). The first polygon (1109) is an example of a n^{th} iterated polygon in the method in FIG. 7. A second polygon (1111), represented by a dashed line, is also interpreted as enclosing the geological features (1105). The area of the second polygon (1111) is smaller than the area of the first polygon (1109). The second polygon (1111) is an example of a (n+1)^{th} iterated polygon in Step 713 in FIG. 7. If the score of a given polygon is defined as the inverse of the area of the given polygon, the second polygon (1111) has a higher score than the first polygon (1109).

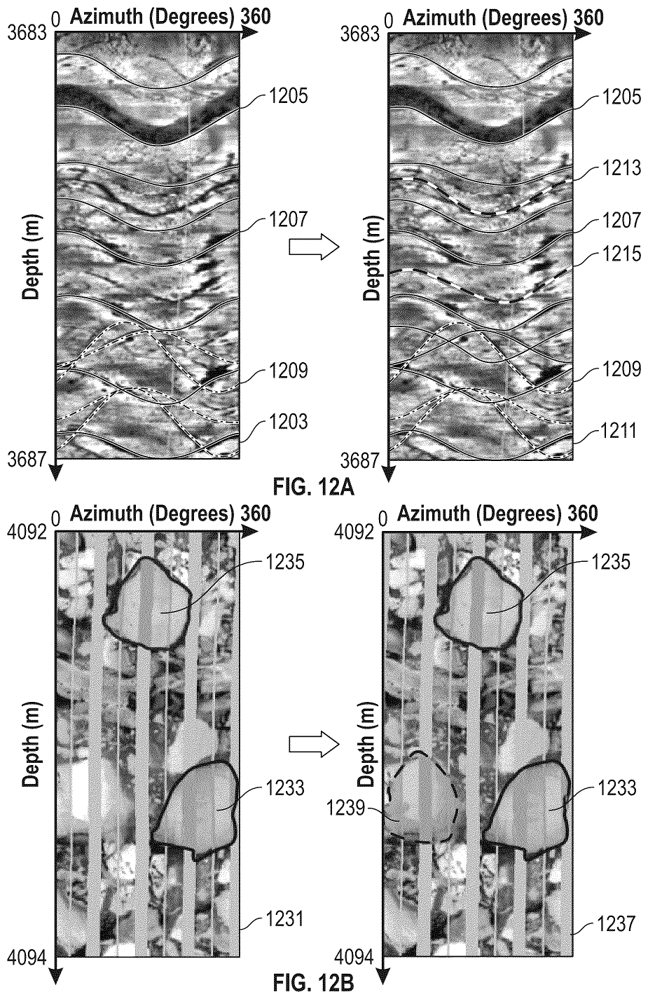

FIGS. 12A and 12B depict example results of new geological features determined by using the AI model. The new geological features are determined in the same fashion as the first new geological feature (515) in FIG. 5 and the new geological feature in Steps 817-831 of the method in FIGS. 8A and 8B. FIG. 12A includes a first UBI (1203) and a second UBI (1211). The second UBI (1211) is a copy of the first UBI (1203). FIG. 12A includes line interpretations of faults and fractures, such as a first line interpretation (1205), a second line interpretation (1207) and a third line interpretation (1209). For each fault and fracture in the first UBI (1203), a descriptor may be determined in the same way as the first descriptor (409) is determined for the first geological feature (407) in FIG. 4. This way, the first UBI (1203) and the descriptors may form a third interpretation example, in the same fashion as the interpretation example (417) in FIG. 4 and the first interpretation example (503) in FIGS. 5 and 6. By applying the AI model to the third interpretation example and following the system (500) in FIG. 5 or Steps 819-831 in FIGS. 8A and 8B, two new fractures are discovered. The two new fractures are represented as a first dashed line (1213) and a second dashed line (1215), overlaid on the second UBI (1211) in FIG. 12A. Then, new descriptors may be determined for the two new fractures and appended to the output of the third interpretation example.

FIG. 12B includes a first FMI (1231) and second FMI (1237). The second FMI (1237) is a copy of the first FMI (1231). FIG. 12B includes line interpretations of two nodules: a fourth line interpretation (1233) and a fifth line interpretation (1235). For each nodule in the first FMI (1231), a descriptor may be determined in the same way as the first descriptor (409) is determined for the first geological feature (407) in FIG. 4. This way, the first FMI (1231) and the descriptors may form a fourth interpretation example, in the same fashion as the interpretation example (417) in FIG. 4 and the first interpretation example (503) in FIGS. 5 and 6. By applying the AI model to the fourth interpretation example and following the system (500) in FIG. 5 or Steps 819-831 in FIGS. 8A and 8B, a new nodule is discovered. The new nodule is represented as a third dashed line (1239), overlaid on the second FMI (1237) in FIG. 12B. Then, a new descriptor may be determined for the new nodule and appended to the fourth interpretation example.

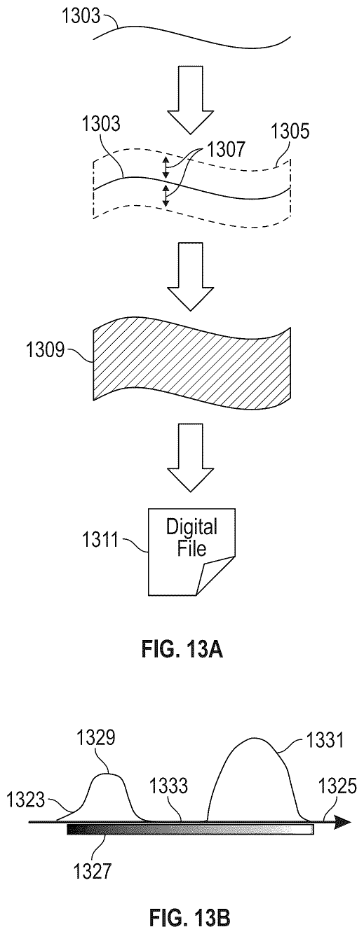

FIG. 13A depicts example results of some steps of the specific embodiment of the optimizer (405) described in FIG. 7. An interpreted fracture (1303) is located in a borehole image, according to Step 703 of the optimizer from FIG. 7. The interpreted fracture (1303) follows a substantially sinusoidal pattern. An iterated polygon (1305) is designed to enclose the interpreted fracture (1303). The polygon (1305) is a substantially sinusoidal band, following the interpreted fracture (1303). The iterated polygon (1305) illustrates the first iterated polygon from Step 705 and the (n+1)^{th} iterated polygon from Step 713 of the optimizer in FIG. 7. The area of the iterated polygon (1305) is reduced as the optimizer is iterated according to Steps 707-715, based on the brightness of the borehole image within the iterated polygon (1305). In the specific example in FIG. 13A, the size of the iterated polygon (1305) is reduced in a reduction direction (1307). The optimizer is iterated until the average brightness of the borehole image inside the iterated polygon (1305) is higher than a pre-defined brightness threshold. The iterated polygon (1305) at the last iteration is selected as an optimum polygon (1309). The optimum polygon (1309) is saved as a digital file (1311) in a suitable file format to be used in the AI model (509) from FIGS. 5 and 6. Suitable file formats known in the art include, for example, a binary format and a .json format.

FIG. 13B depicts a distribution (1323) of the values of the brightness of each pixel of the portion of the borehole image inside the optimum polygon (1309). The brightness is evaluated along a brightness axis (1325). The values to the right of the brightness axis (1325) correspond to higher values of the brightness. The values to the left of the brightness axis (1325) correspond to lower values of the brightness. A brightness colormap (1327) follows the brightness axis (1325). The lighter colors of the brightness colormap (1327) correspond to higher values of the brightness. The darker colors of the brightness colormap (1327) correspond to lower values of the brightness. In this specific example, the distribution (1323) includes a first lobe (1329) and a second lobe (1331). The pixels distributed along the first lobe (1329) have lower brightness values than the pixels distributed along the second lobe (1331). In some embodiments, the second lobe (1331) is interpreted as a distribution of pixels, within a first portion of the optimum polygon (1309), that coincide with the interpreted fracture (1303). In these embodiments, the first lobe (1329) is interpreted as a distribution of pixels, within a second portion of the optimum polygon (1309), that do not coincide with the interpreted fracture (1303). The distribution (1321) further includes a substantially flat segment (1333), between the first lobe (1329) and the second lobe (1331). The amplitudes of the distribution (1323) within the substantially flat segment (1333) are significantly lower than the amplitudes of the distribution (1321) within the first lobe (1329) and second lobe (1331). In some embodiments, the fact that the amplitudes within the substantially flat portion (1333) are significantly lower than the amplitudes within the first lobe (1329) and second lobe (1331) indicates a sharp contrast of the borehole image between the first and second portions of the optimum polygon (1309).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining N≥1 borehole images, wherein N is an integer;
locating, in each borehole image within the N borehole images, one or more geological features associated with the borehole image; and
determining, for each borehole image within the N borehole images, one or more descriptors associated with the borehole image, each descriptor of the one or more descriptors comprising an optimum polygon enclosing a geological feature of the one or more geological features associated with the borehole image.

2. The method of claim 1 wherein N≥2, further comprising:
constructing a training dataset of training examples, each training example within the training dataset comprising:
a borehole image from the N borehole images, and
the one or more descriptors associated with the borehole image; and;
training, using the training dataset, an artificial intelligence (AI) model configured to receive, as input, a candidate borehole image and return, as output, one or more candidate descriptors associated with the candidate borehole image, each candidate descriptor within the one or more candidate descriptors comprising a candidate polygon.

3. The method of claim 2, further comprising:
selecting a first borehole image from the N borehole images;
determining, using the AI model with the first borehole image as input, one or more predicted descriptors associated with the first borehole image;
selecting a first predicted descriptor within the one or more predicted descriptors, the first predicted descriptor comprising a first predicted polygon;
making a first determination whether a new geological feature, in the first borehole image, intersects an area delimited by the first predicted polygon;
upon determining that a new geological feature, in the first borehole image, intersects an area delimited by the first predicted polygon, making a second determination whether the new geological feature belongs to the one or more geological features associated with the first borehole image; and
upon determining that the new geological feature does not belong to the one or more geological features associated with the first borehole image, performing an extension procedure, comprising:
determining a new descriptor associated with the first borehole image, the new descriptor comprising a new optimum polygon enclosing the new geological feature, and
appending the new descriptor to the one or more descriptors associated with the first borehole image.

4. The method of claim 2, further comprising:
obtaining an instance borehole image of an instance borehole, the N borehole images not comprising the instance borehole image;
determining, using the AI model with the instance borehole image as input, one or more inferred descriptors associated with the instance borehole image;
determining, based on the one or more inferred descriptors, a geological map of a vicinity of the borehole.

5. The method of claim 2, wherein the AI model includes a neural network.

6. The method of claim 1, wherein the one or more geological features comprise one or more of:
a fracture;
a vug; and
a nodule.

7. The method of claim 1, wherein the optimum polygon is determined by using an optimizer based on a coherency of the borehole image.

8. The method of claim 1, wherein each descriptor within the one or more descriptors further comprises a label for the geological feature enclosed by the optimum polygon in the descriptor.

9. A system, comprising:
a borehole data acquisition system configured to acquire borehole data from N≥1 boreholes, wherein N is an integer;
a borehole imager, configured to determine N borehole images, each borehole image within the N borehole images determined from borehole data for a distinct borehole within the N boreholes;
a geological locator, configured to locate, in a borehole image, one or more geological features associated with the borehole image;
a computer comprising one or more computer processors, configured to:
receive the N borehole images from the borehole imager;
locate, using the geological locator, in each borehole image within the N borehole images, one or more geological features associated with the borehole image; and
determine, for each borehole image of the N borehole images, one or more descriptors associated with the borehole image, each descriptor of the one or more descriptors comprising an optimum polygon enclosing a geological feature of the one or more geological features associated with the borehole image.

10. The system of claim 9 wherein N≥2, wherein the computer is further configured to:
construct a training dataset of training examples, each training example within the training dataset comprising:
a borehole image from the N borehole images, and
the one or more descriptors associated with the borehole image; and;
train, using the training dataset, an artificial intelligence (AI) model configured to receive, as input, a candidate borehole image and return, as output, one or more candidate descriptors associated with the candidate borehole image, each candidate descriptor of the one or more candidate descriptors comprising a candidate polygon.

11. The system of claim 10, wherein the computer is further configured to:
select a first borehole image from the N borehole images;
determine, using the AI model with the first borehole image as input, one or more predicted descriptors associated with the first borehole image;
select a first predicted descriptor of the one or more predicted descriptors, the first predicted descriptor comprising a first predicted polygon;
make a first determination whether a new geological feature, in the first borehole image, intersects an area delimited by the first predicted polygon;
upon determining that a new geological feature, in the first borehole image, intersects an area delimited by the first predicted polygon, make a second determination whether the new geological feature belongs to the one or more geological features associated with the first borehole image; and
upon determining that the new geological feature does not belong to the one or more geological features associated with the first borehole image, perform an extension procedure, comprising:
determining a new descriptor associated with the first borehole image, the new descriptor comprising a new optimum polygon enclosing the new geological feature, and
appending the new descriptor to the one or more descriptors associated with the first borehole image.

12. The system of claim 10, further comprising a mapping system, configured to:
receive an instance borehole image of an instance borehole, the N borehole images not comprising the instance borehole image;
determine, using the AI model with the instance borehole image as input, one or more inferred descriptors associated with the instance borehole image;
determine, based on the one or more inferred descriptors, a geological map of a vicinity of the borehole.

13. The system of claim 10, wherein the AI model includes a neural network.

14. The system of claim 9, wherein the one or more geological features comprise one or more of:
a fracture;
a vug; and
a nodule.

15. The system of claim 9, wherein the optimum polygon is determined by using an optimizer based on a coherency of the borehole image.

16. The system of claim 9, wherein each descriptor of the one or more descriptors further comprises a label for the geological feature enclosed by the optimum polygon in the descriptor.

17. A non-transitory computer-readable memory comprising computer-executable instructions stored thereon that, when executed on a processor, cause the processor to perform steps comprising:
obtaining N≥1 borehole images, wherein N is an integer;
locating, in each borehole image of the N borehole images, one or more geological features associated with the borehole image; and
determining, for each borehole image of the N borehole images, one or more descriptors associated with the borehole image, each descriptor of the one or more descriptors comprising an optimum polygon enclosing a geological feature of the one or more geological features associated with the borehole image.

18. The non-transitory computer-readable memory of claim 17, the steps further comprising:
constructing a training dataset of training examples, each training example within the training dataset comprising:
a borehole image from the N borehole images, and
the one or more descriptors associated with the borehole image; and;
training, using the training dataset, an artificial intelligence (AI) model configured to receive, as input, a candidate borehole image and return, as output, one or more candidate descriptors associated with the candidate borehole image, each candidate descriptor of the one or more candidate descriptors comprising a candidate polygon.

19. The non-transitory computer-readable memory of claim 18, the steps further comprising:
selecting a first borehole image from the N borehole images;
determining, using the AI model with the first borehole image as input, one or more predicted descriptors associated with the first borehole image;
selecting a first predicted descriptor of the one or more predicted descriptors, the first predicted descriptor comprising a first predicted polygon;
making a first determination whether a new geological feature, in the first borehole image, intersects an area delimited by the first predicted polygon;
upon determining that a new geological feature, in the first borehole image, intersects an area delimited by the first predicted polygon, making a second determination whether the new geological feature belongs to the one or more geological features associated with the first borehole image; and
upon determining that the new geological feature does not belong to the one or more geological features associated with the first borehole image, performing an extension procedure, comprising:
determining a new descriptor associated with the first borehole image, the new descriptor comprising a new optimum polygon enclosing the new geological feature, and
appending the new descriptor to the one or more descriptors associated with the first borehole image.

20. The non-transitory computer-readable memory of claim 18, the steps further comprising:
obtaining an instance borehole image of an instance borehole, the N borehole images not comprising the instance borehole image;
determining, using the AI model with the instance borehole image as input, one or more inferred descriptors associated with the instance borehole image;
determining, based on the one or more inferred descriptors, a geological map of a vicinity of the borehole.
